(19) United States
(12) Patent Application Publication
(10) Pub. No.: US 2008/0036700 A1
(43) Pub. Date: Feb. 14, 2008

(54) PLASMA DISPLAY APPARATUS AND METHOD OF DRIVING THE SAME

(76) Inventors: Janghwan Cho, Seoul (KR); Hyunil Park, Seongnam-si (KR); Changjoon Park, Seoul (KR); Sunghwan Kim, Seoul (KR)

Correspondence Address: BIRCH STEWART KOLASCH & BIRCH, PO BOX 747, FALLS CHURCH, VA, 22040-0747, US

(21) Appl. No.: 11/837,394

(22) Filed: Aug. 10, 2007

(30) Foreign Application Priority Data
Aug. 10, 2006 (KR) 10-2006-0075909

(51) Int. Cl. G09G 3/28

(52) U.S. Cl. 345/60

(57) ABSTRACT

A plasma display apparatus and a method of driving the same are disclosed. The plasma display apparatus includes a plasma display panel including a first electrode and a second electrode connected to a reference voltage source, and a sustain driver that includes a capacitor performing charge and discharge operations. The sustain driver supplies a first voltage to the first electrode and one terminal of the capacitor, and supplies a second voltage of the other terminal of the capacitor to the second electrode. The second voltage is lower than the first voltage.

This application claims the benefit of Korean Patent Application No. 10-2006-0075909 filed on Aug. 10, 2006, which is hereby incorporated by reference.

### BACKGROUND OF THE DISCLOSURE

1. Field of the Disclosure

This document relates to a plasma display apparatus and a method of driving the same.

2. Description of the Related Art

A plasma display apparatus generally includes a plasma display panel displaying an image, and a driver attached to the rear of the plasma display panel to drive the plasma display panel.

The plasma display panel has the structure in which harrier ribs formed between a front substrate and a rear substrate thereof form unit discharge cell or discharge cells. Each discharge cell is filled with an inert gas containing a main discharge gas such as neon (Ne), helium (He) or a mixture of Ne and He, and a small amount of xenon (Xe). The plurality of discharge cells form one pixel. For instance, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

### SUMMARY OF THE DISCLOSURE

In one aspect, a plasma display apparatus comprises a plasma display panel including a first electrode and a second electrode connected to a reference voltage source, and a sustain driver that includes a capacitor performing charge and discharge operations, supplies a first voltage to the first electrode and one terminal of the capacitor, and supplies a second voltage of the other terminal of the capacitor to the second electrode, the second voltage being lower than the first voltage.

A period of time during which one terminal of the capacitor is charged to the first voltage may be longer than a period of time during which the second voltage of the other terminal of the capacitor is supplied to the second electrode.

The reference voltage source may be a frame attached to the plasma display panel.

The reference voltage source may be formed of a conductive material.

The reference voltage source may supply a ground level voltage.

A voltage level of the first electrode may be maintained at a positive sustain voltage based on the reference voltage source while the first voltage is supplied to the first electrode. A voltage level of the first electrode may be maintained at a negative sustain voltage based on the reference voltage source while the second voltage is supplied to the second electrode.

In another aspect, a plasma display apparatus comprises a plasma display panel including a first electrode and a second electrode connected to a reference voltage source, and a capacitor that performs charge and discharge operations, a first sustain controller that supplies a first voltage output from a constant voltage source to the first electrode and one terminal of the capacitor, a voltage maintenance unit that maintains a voltage charged to the capacitor, an inductor unit that generates resonance between the plasma display panel and the inductor unit, a resonance controller that swings a voltage level of the first electrode between the first voltage and a second voltage through resonance between the plasma display panel and the inductor unit, a second sustain controller that supplies the second voltage of the other terminal of the capacitor to the second electrode, and a reverse current blocking unit that is electrically connected to the inductor unit and the resonance controller to block a reverse current.

A period of time during which one terminal of the capacitor is charged to the first voltage may be longer than a period of time during which the second voltage of the other terminal of the capacitor is supplied to the second electrode.

The reference voltage source may be a frame attached to the plasma display panel.

The reference voltage source may be formed of a conductive material.

The reference voltage source may supply a ground level voltage.

A voltage level of the first electrode may be maintained at a positive sustain voltage based on the reference voltage source while the first voltage is supplied to the first electrode. A voltage level of the first electrode may be maintained at a negative sustain voltage based on the reference voltage source while the second voltage is supplied to the second electrode.

The resonance controller may include a first resonance switch operated so that a voltage level of the first electrode changes from the first voltage to the second voltage, and a second resonance switch operated so that a voltage level of the first electrode changes from the second voltage to the first voltage.

The inductor unit may include a first inductor that generates resonance so that a voltage level of the first electrode changes from the first voltage to the second voltage, and a second inductor that generates resonance so that a voltage level of the first electrode changes from the second voltage to the first voltage.

An inductance of the first inductor may be different from an inductance of the second inductor.

The reverse current blocking unit may include a first diode that blocks a current flowing from the resonance controller into the inductor unit, and a second diode that blocks a current flowing from the inductor unit into the resonance controller.

In still another aspect, a method of driving a plasma display apparatus including a capacitor performing charge and discharge operations, a first electrode, and a second electrode connected to a reference voltage source, the method comprises supplying a first voltage output from a constant voltage source to the first electrode and one terminal of the capacitor, changing a voltage level of the first electrode from the first voltage to a second voltage lower than the first voltage through resonance between the plasma display panel and an inductor unit, supplying the second voltage of the other terminal of the capacitor to the second electrode, and changing a voltage level of the first electrode from the second voltage to the first voltage through resonance between the plasma display panel and the inductor unit.

A period of time during which one terminal of the capacitor is charged to the first voltage may be longer than a period of time during which the second voltage of the other terminal of the capacitor is supplied to the second electrode.

A period of time during which the voltage level of the first electrode changes from the first voltage to the second voltage may be different from a period of time during which the voltage level of the first electrode changes from the second voltage to the first voltage.

The reference voltage source may supply a ground level voltage.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates a plasma display apparatus according to an exemplary embodiment;

FIG. 2 illustrates a structure of a plasma display panel of FIG. 1;

FIG. 3 illustrates a method of driving the plasma display apparatus according to an exemplary embodiment;

FIG. 4 illustrates a sustain driver corresponding to a first driver;

FIG. 5 is a switching timing diagram for explaining an operation of the sustain driver of FIG. 4; and

FIGS. 6A to 6D illustrate a method for operating the sustain driver of FIG. 4 in response to the switching timing of FIG. 5.

### DETAILED DESCRIPTION OF EMBODIMENTS

Embodiments will be described in a more detailed manner with reference to the attached drawings.

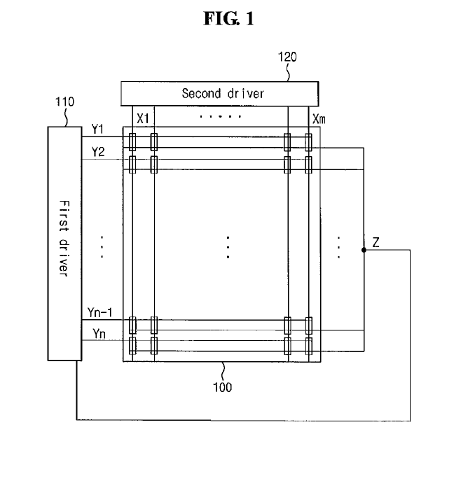

FIG. 1 illustrates a plasma display apparatus according to an exemplary embodiment.

As illustrated in FIG. 1, the plasma display apparatus according to an exemplary embodiment includes a plasma display panel 100 including first electrodes Y1 to Yn, second electrodes Z, and third electrodes X1 to Xm, a first driver 110, and a second driver 120.

The first and second drivers 110 and 120 supply predetermined driving voltages to the plurality of electrodes of the plasma display panel 100 during several subfields of one frame.

The first driver 110 drives the first electrodes Y1 to Yn of the plasma display panel 100. The first electrodes Y1 to Yn and the second electrodes Z may be a scan electrode and a sustain electrode, respectively.

The first driver 110 may supply a reset signal to the first electrodes Y1 to Yn, thereby initializing wall charges inside discharge cells. Further, the first driver 110 supplies a scan signal for selecting cells to be discharge and a sustain signal for generating a sustain discharge to the first electrodes Y1 to Yn.

While the first driver 110 supplies the sustain signal to the first electrodes Y1 to Yn, a reference voltage output from a reference voltage source may be supplied to the second electrodes Z electrically connected to the reference voltage source.

The reference voltage source electrically connected to the second electrodes Z may be a frame attached to the rear of the plasma display panel 100, or may be formed in a predetermined area using an electrically conductive material. For instance, the reference voltage source may be a frame or may be formed in the form of a cooper foil having a predetermined area.

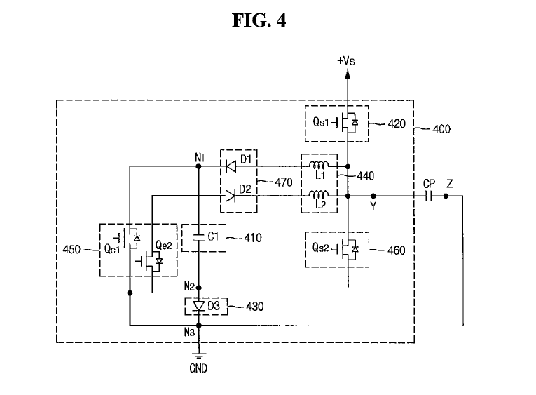

More specifically, a sustain driver included in the first driver 110 supplies a sustain signal to the first electrodes Y1 to Yn. A configuration of the sustain driver will be described in detail below with reference to FIG. 4.

The sustain driver supplies a first voltage output from a constant voltage source to the first electrodes Y1 to Yn. Hence, a voltage level of the first electrodes Y1 to Yn is maintained at a positive sustain voltage based on the reference voltage, and one terminal of a capacitor included in the sustain driver is charged to the first voltage. A second voltage of the other terminal of the capacitor is supplied to the first electrodes Y1 to Yn, and thus a voltage level of the first electrodes Y1 to Yn can be maintained at a negative sustain voltage based on the reference voltage.

A period of time during which the first voltage is supplied to the first electrodes Y1 to Yn and at the same time one terminal of the capacitor is charged to the first voltage may be longer than a period of time during which the second voltage of the other terminal of the capacitor is supplied to the first electrodes Y1 to Yn.

In an exemplary embodiment, the negative sustain voltage can be supplied to the first electrodes Y1 to Yn without a separate negative constant voltage source. In other words, the first electrodes Y1 to Yn is charged to a charging voltage of one terminal of the capacitor during the supply of the positive sustain voltage to the first electrodes Y1 to Yn. Then, the negative sustain voltage is supplied to the first electrodes Y1 to Yn using a charging voltage of the other terminal of the capacitor.

The first driver 110 supplies the highest voltage (i.e., the positive sustain voltage) and the lowest voltage (i.e., the negative sustain voltage) of the sustain signal to the first electrodes Y1 to Yn. The second electrodes Z are electrically connected to the reference voltage source, and thus the reference voltage (equal to a ground level voltage) is supplied to the second electrodes Z. Accordingly, the number of components constituting the driver of the plasma display apparatus is reduced, and the configuration of the driver is simplified. Furthermore, the fabrication cost of the plasma display apparatus is reduced.

The second driver 120 supplies a data signal to the third electrodes X1 to Xm.

FIG. 1 has illustrated and described a case where one driver (i.e., the first driver 110) drives the first electrodes Y1 to Yn and the second electrodes Z. However, a driver for supplying the reset signal and the scan signal to the first electrodes Y1 to Yn and a driver for supplying a bias signal to the second electrodes Z may be separately positioned in the plasma display apparatus, and the sustain driver for supplying the sustain signal to the first electrodes Y1 to Yn and the second electrodes Z may be included in one of the two drivers.

Hereinafter, the plasma display apparatus illustrated in FIG. 1 will be described for the convenience of the explanation as one example.

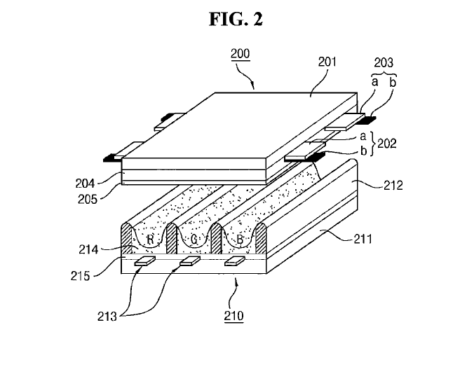

FIG. 2 illustrates a structure of a plasma display panel of FIG. 1.

As illustrated in FIG. 2, the plasma display panel 100 includes a front panel 200 and a rear panel 210 which are coupled in parallel to oppose to each other at a given distance therebetween. The front panel 200 includes a front substrate 201 being a display surface on which an image is displayed. The rear panel 210 includes a rear substrate 211 constituting a rear surface. A plurality of first electrodes 202 and a plurality of second electrodes 203 are formed in pairs on the front substrate 201. A plurality of third electrodes 213 are arranged on the rear substrate 211 to intersect the first electrodes 202 and the second electrodes 203.

The first electrode 202 and the second electrode 203 each include transparent electrodes 202a and 203a made of a transparent material such as indium-tin-oxide (ITO) and bus electrodes 202b and 203b made of a metal material. The first electrode 202 and the second electrode 203 generate a mutual discharge therebetween in one discharge cell and maintain light-emissions of the discharge cells. The first electrode 202 and the second electrode 203 are covered with one or more upper dielectric layers 204 for limiting a discharge current and providing electrical insulation between the first electrode 202 and the second electrode 203. A protective layer 205 with a deposit of Mgo is formed on an upper surface of the upper dielectric layer 204 to facilitate discharge conditions.

A plurality of stripe-type (or well-type) barrier ribs 212 are formed in parallel on the rear substrate 211 to form a plurality of discharge spaces (i.e., a plurality of discharge cells). The plurality of third electrodes 213 for performing an address discharge to generate vacuum ultraviolet rays are arranged in parallel to the barrier ribs 212. An upper surface of the rear substrate 211 is coated with red (R), green (G) and blue (B) phosphors 214 for emitting visible light for an image display during the generation of an address discharge. A lower dielectric layer 215 is formed between the third electrodes 213 and the phosphors 214 to protect the third electrodes 213.

FIG. 2 illustrated only an example of the plasma display panel 100 applicable to an exemplary embodiment. Accordingly, an exemplary embodiment is not limited to the structure of the plasma display panel illustrated in FIG. 2.

For instance, in FIG. 2, the first electrode 202 and the second electrode 203 each include the transparent electrodes 202a and 203a and the bus electrodes 202b and 203b. However, at least one of the first electrode 202 and the second electrode 203 may include only the bus electrode.

Further, FIG. 2 illustrated the upper dielectric layer 204 having a constant thickness. However, the upper dielectric layer 204 may have a different thickness and a different dielectric constant in each area. FIG. 2 illustrated the barrier ribs 212 having a constant interval between the barrier ribs. However, an interval between the barrier ribs 112 forming the blue discharge cell (B) may be larger than intervals between the barrier ribs 112 forming the red and green discharge cells (R and G).

Further, a luminance of an image displayed on the plasma display panel 100 can increase by forming the side of the barrier rib 112 in a concavo-convex shape and coating the phosphor 214 depending on the concavo-convex shape of the barrier rib 112.

A tunnel may be formed on the side of the barrier rib 112 so as to improve an exhaust characteristic when the plasma display panel is fabricated.

In case that only one of the first electrode 202 and the second electrode 203 is formed and a discharge maintaining signal is supplied to the first or second electrode and the third electrode 213, the first or second electrode and the third electrode 213 may be a sustain electrode. FIG. 2 illustrated a case where the plasma display panel includes the first electrode 202, the second electrode 203 and the third electrode 213.

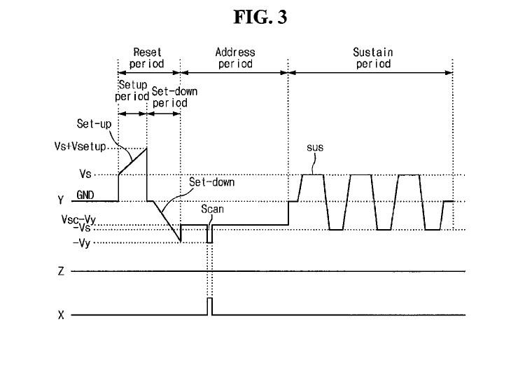

FIG. 3 illustrates a method of driving the plasma display apparatus according to an exemplary embodiment.

As illustrated in FIG. 3, the first and second drivers 110 and 120 of FIG. 1 supply driving signals to the first electrode Y and the third electrode X during at least one of a reset period, an address period, and a sustain period.

The reset period is divided into a setup period and a set-down period. During the setup period, the first driver 110 may supply a setup signal (Set-up) to the first electrode Y. The setup signal generates a weak dark discharge within the discharge cells of the whole screen. This results in wall charges of a positive polarity being accumulated on the second electrode Z and the third electrode X, and wall charges of a negative polarity being accumulated on the first electrode Y.

During the set-down period, the first driver 110 may supply a set-down signal (Set-down), which falls from a positive voltage level lower than the highest voltage of the setup signal (Set-up) to a given voltage level lower than a ground level voltage GND, to the first electrode Y, thereby generating a weak erase discharge within the discharge cells. Furthermore, the remaining wall charges are uniform inside the discharge cells to the extent that the address discharge can be stably performed.

During the address period, the first driver 110 may supply a scan signal (Scan) of a negative polarity falling from a scan bias voltage (Vsc Vy) to the first electrode Y. The second driver 120 may supply a data signal of a positive polarity in synchronization with the scan signal (Scan) to the third electrode X. As a voltage difference between the scan signal (Scan) and the data signal is added to the wall voltage generated during the reset period, an address discharge is generated within the discharge cells to which the data signal is applied. Wall charges are formed inside the discharge cells selected by performing the address discharge to the extent that a discharge occurs whenever a sustain voltage Vs is applied. Hence, the first electrode Y is scanned.

During the sustain period, the sustain driver included in the first driver 110 may supply a sustain signal (sus) to the first electrode Y.

The second electrode Z electrically connected to the reference voltage source is maintained at a voltage level equal to a reference voltage output from the reference voltage source.

As the wall voltage inside the discharge cells selected by performing the address discharge is added to the sustain signal (sus), every time the sustain signal (sus) is applied, a sustain discharge, i.e., a display discharge is generated between the first electrode Y and the second electrode Z.

An erase period may be added in an exemplary embodiment.

FIG. 4 illustrates a sustain driver corresponding to a first driver. The sustain driver 400 includes a capacitor unit 410, a first sustain controller 420, a voltage maintenance unit 430, an inductor unit 440, a resonance controller 450, a second sustain controller 460, and a reverse current blocking unit 470

The capacitor unit 410 includes a capacitor C1 to which a voltage is charged.

The first sustain controller 420 includes a first sustain switch Qs1, and supplies the first voltage output from a constant voltage source (+Vs) to the first electrode Y and one terminal N1 of the capacitor C1. Hence, the capacitor C1 is charged to the first voltage.

The voltage maintenance unit 430 includes a third diode D3. The voltage maintenance unit 430 blocks a reverse current so that a charging voltage of the capacitor C1 is maintained without changes.

The inductor unit 440 includes a first inductor L1 and a second inductor L2. The inductor unit 440 and the plasma display panel Cp generate resonance.

The first inductor L1 and the plasma display panel Cp generate resonance so that a voltage level of the first electrode Y changes from the first voltage to the second voltage. The second inductor L2 and the plasma display panel Cp generate resonance so that a voltage level of the first electrode Y changes from the second voltage to the first voltage. The first voltage and the second voltage may have different polarities and an equal voltage magnitude. Inductances of the first inductor L1 and the second inductor L2 may be different from each other. Therefore, a period of time during which a voltage level of the first electrode Y changes from the first voltage to the second voltage may be different from a period of time during which a voltage level of the first electrode Y changes from the second voltage to the first voltage.

The resonance controller 450 includes a first resonance switch Qe1 and a second resonance switch Qe2. When the first resonance switch Qe1 is turned on, a voltage level of the first electrode Y falls from the first voltage to the second voltage lower than the first voltage through the resonance between the inductor unit 440 and the plasma display panel Cp. When the second resonance switch Qe2 is turned on, a voltage level of the first electrode Y rises from the second voltage to the first voltage through the resonance between the inductor unit 440 and the plasma display panel Cp.

The second sustain controller 460 includes a second sustain switch Qs2. The second voltage of the other terminal N2 of the capacitor C1 is supplied to the first electrode Y, and thus a voltage level of the first electrode Y is maintained at the second voltage.

The reverse current blocking unit 470 includes a first diode D1 and a second diode D2. The reverse current blocking unit 470 is electrically connected to the inductor unit 440 and the resonance controller 450 to block a reverse current.

The first diode D1 blocks a current flowing from the first resonance switch Qe1 into the first inductor L1, and the second diode D2 blocks a current flowing from the second inductor L2 into the second resonance switch Qe2.

The plasma display panel Cp includes the second electrode Z positioned parallel to the first electrode Y. The second electrode z is electrically connected to a reference voltage source (GND). Therefore, a voltage of the reference voltage source is supplied to the second electrode z while the first voltage and the second voltage are supplied to the first electrode Y.

Hence, a separate driver for supplying a driving signal to the second electrode Z is not necessary, and thus the fabrication cost is reduced.

A period of time during which the first voltage is supplied to the first electrode Y and at the same time one terminal N1 of the capacitor C1 is charged to the first voltage may be longer than a period of time during which the second voltage of the other terminal N2 of the capacitor C1 is supplied to the first electrode Y. Hence, although sustain load increases, a voltage drop can be prevented because a voltage is stably charged to the capacitor C1.

A connection relationship between components of the sustain driver 400 will be described below.

One terminal of the first sustain switch Qs1 is connected to the constant voltage source (+Vs), and the other terminal is connected to the first electrode Y.

one terminal of the first inductor L1 is commonly connected to the first electrode Y and the other terminal of the first sustain switch Qs1, and the other terminal is connected to one terminal of the first diode D1.

One terminal of the capacitor C1 is connected to the other terminal of the first diode D1, and the other terminal is connected to one terminal of the third diode D3. Further, the other terminal of the third diode D3 is commonly connected to the second electrode Z and the reference voltage source (GND). One terminal of the reference voltage source (GND) is commonly connected to the other terminal of the first diode D1 and one terminal of the capacitor C1.

One terminal of the first resonance switch Qe1 is commonly connected to the second electrode Z and the other terminal of the third diode D3. One terminal of the second sustain switch Qs2 is commonly connected to the other terminal of the first sustain switch Qs1, the first electrode Y, and one terminal of the first inductor L1, and the other terminal is commonly connected to the other terminal of the capacitor C1 and one terminal of the third diode D3.

One terminal of the second inductor L2 is commonly connected to the other terminal of the first sustain switch Qs1, the first electrode Y, the first inductor L1, and one terminal of the second sustain switch Qs2. The other terminal of the second inductor L2 is connected to one terminal of the second diode D2.

One terminal of the second resonance switch Qe2 is connected to the other terminal of the second diode D2, and the other terminal is commonly connected to the other terminal of the first resonance switch Qe1, the other terminal of the third diode D3, the second electrode Z, and the reference voltage source (GND).

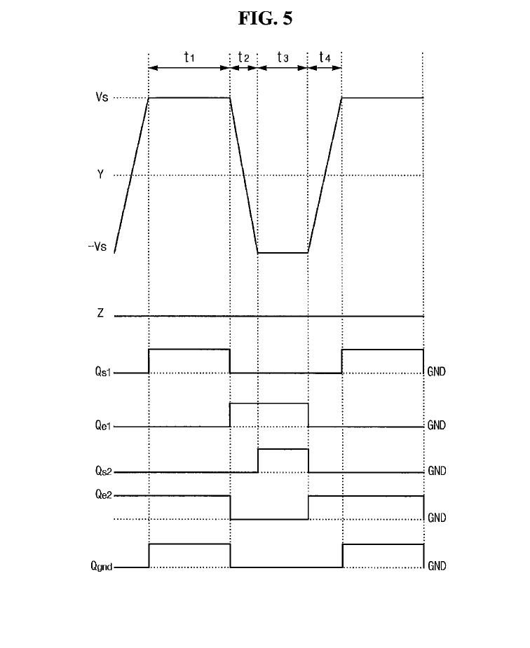

FIG. 5 is a switching timing diagram for explaining an operation of the sustain driver of FIG. 4.

As illustrated in FIG. 5, voltage levels of the first electrode Y and the second electrode Z is set based on the reference voltage output from the reference voltage source (GND).

During a period ti, the first sustain controller 420 is turned on. Hence the first voltage is supplied to the first electrode Y and one terminal N1 of the capacitor C1 is charged to the first voltage. During a period t2, the resonance controller 450 is turned on. Hence, a voltage level of the first electrode Y falls from the first voltage to the second voltage through resonance between the plasma display panel Cp and the inductor unit 440. During a period t3, the second sustain controller 460 is turned on. Hence, the second voltage of the other terminal N2 of the capacitor Cl is supplied to the first electrode Y. During a period t4, the resonance controller 450 is turned on. Hence, a voltage level of the first electrode Y rises from the second voltage to the first voltage through resonance between the plasma display panel Cp and the inductor unit 440.

As above, the supply of the first voltage to the first electrode Y and the charge of one terminal N1 of the capacitor Cl to the first voltage can be performed during the period t1. The period t1 during which one terminal N1 of the capacitor C1 is charged to the first voltage may be longer than the period t3 during which the second voltage of the other terminal N2 of the capacitor C1 is supplied to the first electrode Y.

When the number of sustain signals assigned to a subfield increases, a current flowing into the electrodes of the plasma display panel increase. As a result, a load effect, in which a voltage drop increases, greatly generates. When the voltage drop increase, a voltage is not sufficiently charged to the capacitor C1 in the second half of the sustain signal. Because the period t1 is set to be longer than the period t3 in an exemplary embodiment, the voltage drop capable of generating the load effect can be prevented. A stable sustain discharge can occur and image quality can be improved by the prevention of the voltage drop.

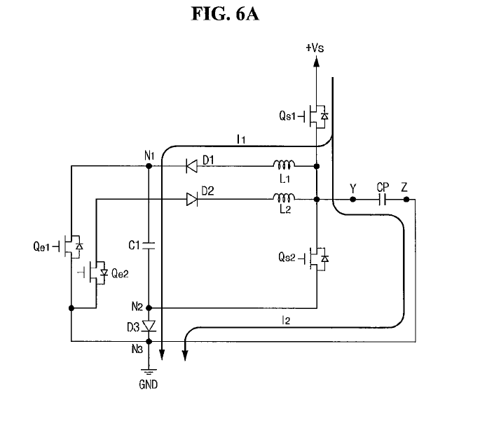

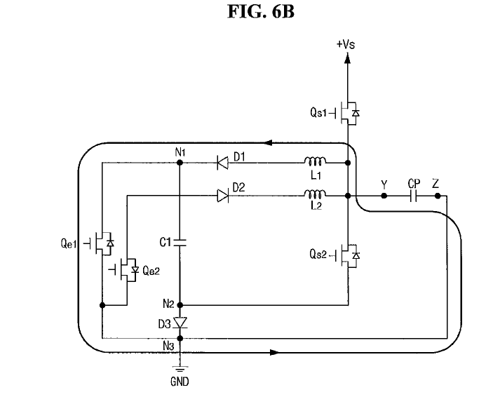

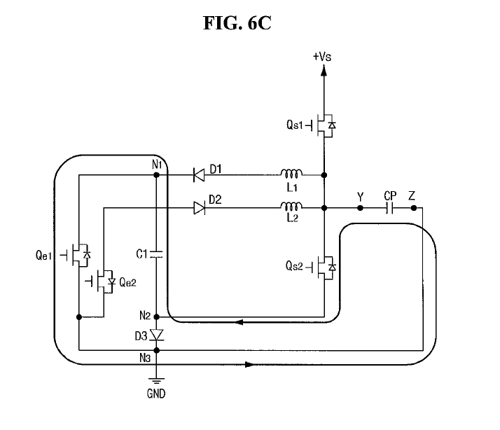

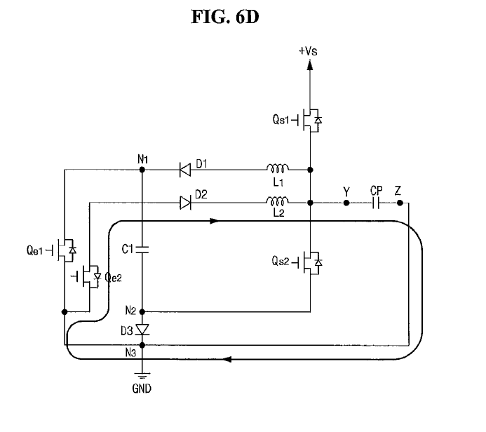

FIGS. 6A to 6D illustrate a method for operating the sustain driver of FIG. 4 in response to the switching timing of FIG. 5.

During the period ti of FIG. 5, the second resonance switch Qe2 remains in a turn-on state, and the first sustain switch Qs1 is turned on.

Hence, as illustrated in FIG. 6A, a first current path I1 passing through the constant voltage source (+Vs), the first sustain switch Qs1, the first inductor L1, the first diode D1, the capacitor C1, the third diode D3, and the reference voltage source (GND) is formed. Further, a second current path 12 passing through the constant voltage source (+Vs), the first sustain switch Qs1, the panel Cp, and the reference voltage source (GND) is formed.

As a result, the first voltage of the constant voltage source (+Vs) is supplied to one terminal N1 of the capacitor C1 and the capacitor C1 is charged to the first voltage.

The first voltage is supplied to the first electrode Y of the panel Cp through the second current path I2. A magnitude of the first voltage is substantially equal to a magnitude of the positive sustain voltage capable of generating the sustain discharge inside the discharge cell.

A voltage in one terminal N1 (called a first node) of the capacitor C1 is substantially equal to the first voltage. A voltage in the other terminal N2 (called a second node) and a third node N3 of the capacitor C1 is substantially equal to a ground level voltage output from the reference voltage source (GND). A voltage level of the first electrode Y is maintained at the first voltage based on the reference voltage source (GND).

A reason why the second resonance switch Qe2 remains in the turn-on state is to stably drive the sustain driver. Accordingly, the second resonance switch Qe2 may remain in the turn-on state during a portion of the period t1, or the second resonance switch Qe2 may remain in the turn-on state during the whole period t1.

During the period t2, the first resonance switch Qe1 is turned on. As illustrated in FIG. 6B, a current path passing through the first electrode Y, the first inductor L1, the first diode D1, the first resonance switch Qe1, the reference voltage source (GND), and the second electrode Z is formed. Hence, resonance occurs between the first inductor L1 and the panel CP, and a voltage level of the first electrode Y gradually falls from the first voltage to the second voltage based on the reference voltage source (GND).

Since both terminals of the capacitor C1 does not participate in the formation of the current path due to the third diode D3, a voltage between both terminals of the capacitor C1 (i.e., a voltage between the first and second nodes N1 and N2) is maintained.

When a voltage level of the first electrode Y falls to the second voltage (−Vs), a voltage of the first node N1 is a ground level voltage. Accordingly, a voltage of the second node N2 is the second voltage (−Vs) and a voltage of the third node N3 is a ground level voltage so that the voltage between the first and second nodes N1 and N2 is maintained.

During the period t3, the first resonance switch Qe1 remains in a turn-on state, and the second sustain switch Qs2 is turned on. As illustrated in FIG. 6C, a current path passing through the first electrode Y, the second sustain switch Qs2, the capacitor C1, the first resonance switch Qe1, the reference voltage source (GND), and the second electrode Y is formed.

Hence, voltages of the first node N1 and the third node N3 are the ground level voltage based on the reference voltage source (GND). Since a voltage between the first and second nodes N1 and N2 of the capacitor C1 is maintained, a voltage of the second node N2 is the second voltage (−Vs). The second voltage (−Vs) supplied to the second node N2 is supplied to the first electrode Y through the second sustain switch Qs2.

The third diode D3 blocks a current flowing from the third node N3 into the second node N2. The reason is that a voltage of the third node N3 is higher than a voltage of the second node N2.

During the period t4, the second resonance switch Qe2 is turned on. As illustrated in FIG. 6D, a current path passing through the second electrode Z, the reference voltage source (GND), the second resonance switch Qe2, the second diode D2, the second inductor L2, and the first electrode Y is formed.

Hence, the first voltage (+Vs) is supplied to the first electrode Y through resonance between the second inductor L2 and the panel Cp. A voltage level of the first electrode Y rises from the second voltage (−Vs) to the first voltage (+vs) based on the reference voltage source (GND).

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel including a first electrode and a second electrode connected to a reference voltage source; and
a sustain driver that includes a capacitor performing charge and discharge operations, supplies a first voltage to the first electrode and one terminal of the capacitor, and supplies a second voltage of the other terminal of the capacitor to the second electrode, the second voltage being lower than the first voltage.

2. The plasma display apparatus of claim 1, wherein a period of time during which one terminal of the capacitor is charged to the first voltage is longer than a period of time during which the second voltage of the other terminal of the capacitor is supplied to the second electrode.

3. The plasma display apparatus of claim 1, wherein the reference voltage source is a frame attached to the plasma display panel.

4. The plasma display apparatus of claim 1, wherein the reference voltage source is formed of a conductive material.

5. The plasma display apparatus of claim 1, wherein the reference voltage source supplies a ground level voltage.

6. The plasma display apparatus of claim 1, wherein a voltage level of the first electrode is maintained at a positive sustain voltage based on the reference voltage source while the first voltage is supplied to the first electrode, and
a voltage level of the first electrode is maintained at a negative sustain voltage based on the reference voltage source while the second voltage is supplied to the second electrode.

7. A plasma display apparatus comprising:
a plasma display panel including a first electrode and a second electrode connected to a reference voltage source;
a capacitor that performs charge and discharge operations;
a first sustain controller that supplies a first voltage output from a constant voltage source to the first electrode and one terminal of the capacitor;
a voltage maintenance unit that maintains a voltage charged to the capacitor;
an inductor unit that generates resonance between the plasma display panel and the inductor unit;
a resonance controller that swings a voltage level of the first electrode between the first voltage and a second voltage through resonance between the plasma display panel and the inductor unit;
a second sustain controller that supplies the second voltage of the other terminal of the capacitor to the second electrode; and
a reverse current blocking unit that is electrically connected to the inductor unit and the resonance controller to block a reverse current.

8. The plasma display apparatus of claim 7, wherein a period of time during which one terminal of the capacitor is charged to the first voltage is longer than a period of time during which the second voltage of the other terminal of the capacitor is supplied to the second electrode.

9. The plasma display apparatus of claim 7, wherein the reference voltage source is a frame attached to the plasma display panel.

10. The plasma display apparatus of claim 7, wherein the reference voltage source is formed of a conductive material.

11. The plasma display apparatus of claim 7, wherein the reference voltage source supplies a ground level voltage.

12. The plasma display apparatus of claim 7, wherein a voltage level of the first electrode is maintained at a positive sustain voltage based on the reference voltage source while the first voltage is supplied to the first electrode, and
a voltage level of the first electrode is maintained at a negative sustain voltage based on the reference voltage source while the second voltage is supplied to the second electrode.

13. The plasma display apparatus of claim 7, wherein the resonance controller includes a first resonance switch operated so that a voltage level of the first electrode changes from the first voltage to the second voltage, and a second resonance switch operated so that a voltage level of the first electrode changes from the second voltage to the first voltage.

14. The plasma display apparatus of claim 7, wherein the inductor unit includes a first inductor that generates resonance so that a voltage level of the first electrode changes from the first voltage to the second voltage, and a second inductor that generates resonance so that a voltage level of the first electrode changes from the second voltage to the first voltage.

15. The plasma display apparatus of claim 14, wherein an inductance of the first inductor is different from an inductance of the second inductor.

16. The plasma display apparatus of claim 7, wherein the reverse current blocking unit includes a first diode that blocks a current flowing from the resonance controller into the inductor unit, and a second diode that blocks a current flowing from the inductor unit into the resonance controller.

17. A method of driving a plasma display apparatus including a capacitor performing charge and discharge operations, a first electrode, and a second electrode connected to a reference voltage source, the method comprising:
supplying a first voltage output from a constant voltage source to the first electrode and one terminal of the capacitor;
changing a voltage level of the first electrode from the first voltage to a second voltage lower than the first voltage through resonance between the plasma display panel and an inductor unit;
supplying the second voltage of the other terminal of the capacitor to the second electrode; and
changing a voltage level of the first electrode from the second voltage to the first voltage through resonance between the plasma display panel and the inductor unit.

18. The method of claim 17, wherein a period of time during which one terminal of the capacitor is charged to the first voltage is longer than a period of time during which the second voltage of the other terminal of the capacitor is supplied to the second electrode.

19. The method of claim 17, wherein a period of time during which the voltage level of the first electrode changes from the first voltage to the second voltage is different from a period of time during which the voltage level of the first electrode changes from the second voltage to the first voltage.

20. The method of claim 17, wherein the reference voltage source supplies a ground level voltage.
